(19) United States
(12) Patent Application Publication
(10) Pub. No.: US 2004/0173997 A1
(43) Pub. Date: Sep. 9, 2004

(54) Combination car seat, carrier, and stroller for infants

(76) Inventor: Rachelle Voll, Yorba Linda, CA (US)

Correspondence Address: RACHELLE JANETTE VOLL, 17131 SAGA DRIVE, YORBA LINDA, CA, 92886, US

(21) Appl. No.: 10/376,018

(22) Filed: Mar. 3, 2003

(51) Int. Cl. B62B 1/00

(52) U.S. Cl. 280/652; 280/655.1

(57) ABSTRACT

An improved combination stroller, car seat and carrier for infants comprising a pair of wheels and a handle mounted on a pair of collapsible tubular members mounted through a pair of spaced-apart openings in the outward extending lip rimming the uppermost portion of the back of the seat and anchored to a single axle secured to the rear underside portion of the seat. When the pair of collapsible tubular members are collapsed for use as a car seat for infants inside the motor vehicle, the handle and pair of collapsible tubular members are disposed in a stowed position against the seat back portion of the car seat. The bottom portion of the combination is adapted for disposition in lockable securement either directly to the seat belt safety system of an motor vehicle, such as a car or automobile, or the like, or via an interlocking tray mounted on a seating surface inside the motor vehicle and secured to the body or frame of the motor vehicle.

### BACKGROUND OF THE INVENTION

1. Field of the Invention

The present invention relates to a combination stroller, car seat and carrier for infants with a collapsible handle, and, more particularly, to such a combination including a pair of wheels mounted on the ends of a single axle secured to the rear underside portion of the seat and a handle secured to a pair of collapsible tubular members passed through a pair of spaced-apart openings in the outward extending lip rimming the uppermost portion of the back of the seat with the ends thereof anchored to the single axle.

2. Description of the Prior Art

One of the most significant problems which are often featured in numerous campaigns by safety groups, insurance companies and legislatures is that of infant car safety laws for protecting infants while being transported in motor vehicles, such as cars and the like. Both the need for education of the general population and workable safety devices to implement these goals is paramount in today's society filled with fast traveling, numerous vehicles plying the freeways and parkways throughout the United States of America. In fact, it is well noted that many jurisdictions now mandate that infants and small children be provided with a special infants' car seat for protectively holding and restraining the infant in the motor vehicle during vehicular movement to protect the infant in the event of a vehicular collision

As such, parents must carry in their vehicles two different and typically rather bulky items; namely: a child's car safety seat and carrier for use during transportation of the infant and an infant's stroller or baby carriage for use when the motor vehicle arrives at the intended destination.

This problem has been addressed by providing combination devices which function as both infant car seats and strollers on wheels. Examples of such combinations found in the prior art known to the Applicant herein are as follows.

U.S. Pat. No. 5,022,669 (Johnson) was issued on Jun. 11, 1991 and relates to a child's travel seat for automobiles, trucks and the like. As shown and described in this patent, there is shown a child travel “which is simply and easily converted to a child stroller.” [Column 1, Lines 38, 39]. It consists of the child travel seat 10, multiple wheel assemblies 110 mounted within the base of the travel seat 10 below the seat portion 16, and a handle 108 which can be rigidly interlocked in the stroller configuration to allow for a “full manipulation of the travel seat from the handle in the manner of a standard stroller.” [Col. 6, Lines 67,68]. However, this combination envisions the use of multiple wheel assemblies 110 and a pivoting non-collapsible handle 108 the bottom extremity of which is not anchored, but is moveable from its “handle position” to its “stowed” position.

U.S. Pat. No. 5,104,134 (Cone) issued on Apr. 14, 1992 and relates to a child's combination carseat and stroller 10 consisting of a seat portion 16, front and rear wheel assemblies 14 and 15, and a telescoping handle 13. The entire stroller is collapsible into a functional car seat. However, the rear wheel assemblies 14, 15 are retractable and are mounted on a pair of independent axles, and the bottom of the stem members 91 of the handle section 13 are moveable and not fixed.

U.S. Pat. No. 5,318,311 (Bofill), a Jun. 7, 1994 patent, relates to a combination child vehicle seat and stroller 10 consisting of a seat portion 11, collapsible handles 21 and 22, and two collapsible wheel assemblies 23 an 24 mounted on independent axles. The bottom portions of the collapsible pair of handles 21 and 22 are moveable and not fixed.

U.S. Pat. No. 5,595,393 (Batten) describes an infant car seat stroller conversion and method therefor. This patent shows the combination of a seat, a set of front and rear wheels, and a retractable handle. Once again, in this combination, there is shown the use of multiple axles for the rear wheels of the stroller, and the bottom portions of the collapsible handle are not anchored or fixed, but are movable.

U.S. Pat. No. 5,890,762 was issued to Yoshida on Apr. 6, 1999 and shows a child's seat which is capable of being adjusted to a reclining angle and seat belted into a vehicle seat. No conversion to a stroller is described or shown. It does not show, or teach, the use of a collapsible handle and a pair of rear wheel combination to create a convertible stroller and infant seat combination.

U.S. Pat. No. 5,947,555 (Welsh, et al.) describes an infant seat and stroller coupling system. A separate infant car seat (or carrier 10) is shown mateable to a separate stroller 40. A releaseable lock-latching mechanism provides a means whereby the seat 10 and stroller 40 can be locked together eliminating the need for removing the infant from the car seat 10 to set the infant in the stroller 40. The rear wheels are mounted on independent axles and there is no collapsible handle allowing this infant seat and stroller to be uniquely convertible as taught by the applicant's invention disclosed hereinafterwards.

U.S. Pat. No. 6,347,832 (Mori) relates to a tiltable child seat for securement to a vehicle seat. The primary invention relates to the tilting mechanism for the child's car seat.

U.S. Pat. No. 6,367,821 (Thiele) teaches a combination of car seat and stroller assembly for infants. As shown in FIG. 2A, there is an infant seat 6, a retractable handle 5, and a pair of wheels 3. However, the rear wheels are not mounted on a single axle, and the bottom portions of the handle 12 and 13 are not fixedly secured, or mounted to the rear wheel axles.

None of the various suggested or illustrated features of the applicant's invention are individually or collectively disclosed in one or more of the patent references discovered by the Applicant in the prior art.

Further, it should also be noted that none of these prior art patents teach the use of in-line polyurethane inline skate wheels for keyed engagement with a separate base unit lockably coupled to a mounting tray which is secured to the seat belt safety system typically found in a motor vehicle such as an automobile, truck or sports utility vehicle (“SUV”).

Consequently, no single patent reference discloses the most prominent features of the present inventive combination, and, as such, said features would not be obvious in combination with the features of the prior art devices to produce the unique combination created by the Applicant as disclosed herein.

The present invention still further discloses features that are not shown in any of the prior art located by the Applicant.

The specific details contained in the present invention disclosed herein by the applicant is set forth in order to clearly delineate the applicant's invention from the prior art hereinabove.

### SUMMARY OF THE INVENTION AND OBJECTS

Fundamentally, the present invention disclosed herein is an improved combination car seat, carrier, and stroller for infants comprising a pair of wheels and a handle mounted on a pair of collapsible tubular members mounted through a pair of spaced-apart openings in the outward extending lip rimming the uppermost portion of the back of the seat and anchored to a single axle secured to the rear underside portion of the seat. When the pair of collapsible tubular members are collapsed for use as a car seat for infants inside the motor vehicle , the handle and pair of collapsible tubular members are disposed in a stowed position against the seat back portion of the car seat. The bottom portion of the combination is adapted for disposition in lockable securement either directly to the seat belt safety system of an motor vehicle, such as a car or automobile, or the like, or via an interlocking tray mounted on a seating surface inside the motor vehicle and secured to the body or frame of the motor vehicle.

One of the objects of the present invention is to provide a simple and inexpensive combination carrier, car safety seat and stroller for infants.

It is another object and important feature of the present invention is to provide a combination carrier, car safety seat and stroller for infants which can be readily and easily converted between use as a stroller and as a car safety seat.

It is yet another and still further important feature of the instant invention herein to use polyurethane in-line skating wheels for use in this unique combination.

Another important and significant feature and important object of the instant invention is to provide a combination infant's car seat and stroller with a collapsible handle with the bottom end of the handle operably mounted to the axle of the rear wheels of the stroller.

A yet still further and important feature of the present invention is to provide a a combination infant's car seat and stroller which can be readily and safely converted between modes for use as a car seat and as a stroller.

It is a further object and primary feature of the within invention to provide an apparatus which is convertible between a car seat and a stroller, and which can be adaptively and securely interlocked with the existing seat belt safety system typically used in motor vehicles such as a cars and automobiles.

Another object and feature of the present invention is the adaptive use of a single axle to which the rear wheels are rotatably mounted and to which the end or ends of the collapsible handle of the stroller feature of the present invention is securely anchored for greatly improved strength and leverage and control of the rear wheels of the stroller during the operation of the stroller feature.

It is another feature and object of the invention herein to adaptively stow the collapsible handle with the seat back of the car seat portion of the present invention.

A yet still further primary feature and object of the invention herein is to

One significant and further important feature of the instant invention described herein is the use of the improved combination incorporating a stroller feature utilizing only a pair of spaced apart wheels mounted to the rearwardly facing bottom of the seat which eliminates the additional weight of the four-wheel convertible combination car seat strollers in the prior art.

As can be realized by one familiar and skilled in the art to which the present invention applies, the above specification of the invention provides a new and useful device for transporting infants both in the automobile during transportation from one point to another and upon the automobile reaching it's appointed destination.

The present invention has arisen to mitigate and/or obviate the aforementioned disadvantages of the conventional prior art combination devices. These together with other objects of the invention, along with the various features of novelty which characterize the invention herein, are described with particularity in the claims appended hereto and forming a part of this application. For a more complete and further and better understanding of the invention, its operating advantages and the specific objects obtained by its applications and uses, reference should be had to the accompanying drawings and description mater in which there is illustrated preferred embodiments of the invention.

### BRIEF DESCRIPTION OF THE DRAWINGS

The aforementioned and other features, advantages and objections of the invention described herein will become more readily apparent as the description of the preferred embodiments of the invention proceed further hereinafterwards as illustrated in the accompanying drawings in which reference characters refer to the identical parts throughout the various figures. It should be noted that the figures depicted in the drawings are not to scale with emphasis being placed instead upon the illustration of the operative principles of the present embodiment of the invention.

FIG. 1 depicts the improved combination car seat, carrier, and stroller for infants of the instant invention when the combination is operating in the stroller mode.

FIG. 2 is generally a side elevation view of one embodiment of the improved combination invention presented herein shown with the handle fully extended for steering and directing the wheeled combination infant stroller, safety seat and carrier following removal from the motor vehicle.

FIG. 3 is a rear elevation view of the present embodiment of the improved combination invention disclosed herein with the steering handle collapsed in its stowed position such as it would be when placed inside of the motor vehicle and safely locked with the seat belt safety system in the motor vehicle, or any similar type of infant car seat locking system.

FIG. 4 is an enlarged view of the pair of wheels mounted on the ends of a single axle and the pair of collapsible tubular members anchored to the axle.

FIG. 5 is an enlarged view of one of the pair of wheels rotatably secured to the end of the axle via a nut threadably engaged with the male threaded portion about the end of the axle.

FIG. 6 is the typical interlocking mechanism of the pair of tube members forming the telescoping handle assembly of the present invention.

FIG. 7 is the cross-sectional view of the typical interlocking mechanism taken along Plane A-A of FIG. 6.

### DETAILED DESCRIPTION OF THE PREFERRED EMBODIMENT

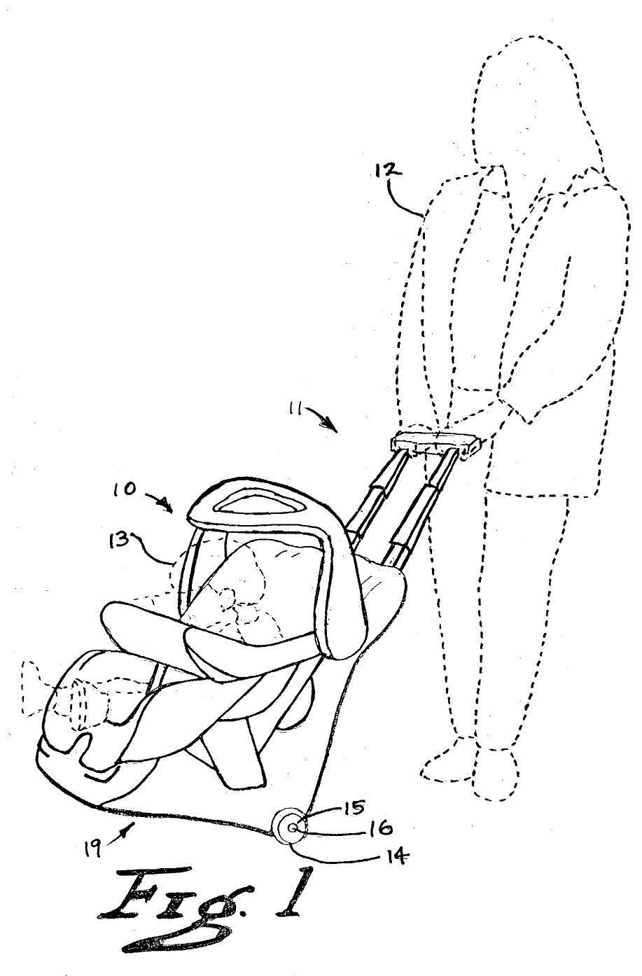

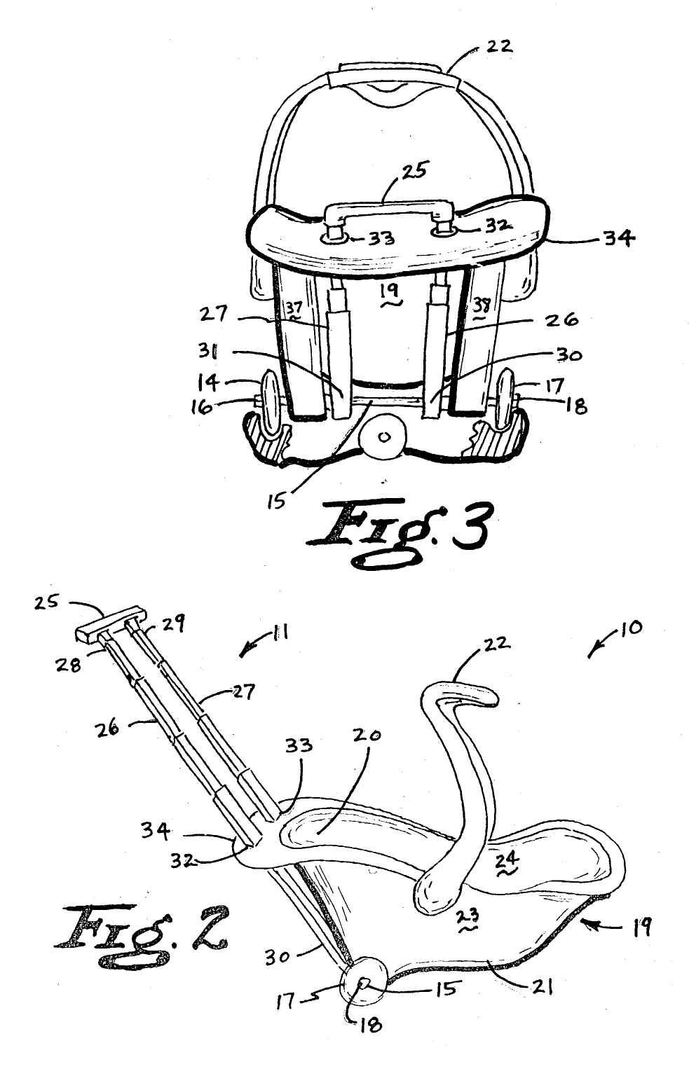

With continuing reference to all of the drawings herein, and, more specifically, now to FIG. 1 of the drawings herein, there is shown one preferred embodiment of the improved combination infant carrier, car seat, and stroller of the instant invention generally indicated at 10 and shown after having been converted from an car seat and carrier for an infant to its stroller mode. This is accomplished by unlocking the carrier, car seat and stroller combination 10 from its lockable engagement with either the safety belt or interlocking latching mechanisms presented on the seat of the motor vehicle for securing the car seat and infant carrier to the frame of the motor vehicle, and by extending an extensible handle assembly generally shown at 11. A pair of wheels, only one wheel 14 of which is shown in FIG. 1, are rotatably mounted on opposite ends of a single axle 15 and when the combination 10 is lowered sufficiently, engage the surface of the ground. The wheel 14 is typically secured to the end of the single axle 15 mounted to the bottom of the car seat by means of a nut 16 threadably mated to the male threaded portion of the end of the axle 15.

Also illustrated in FIG. 1 is an outlined silhouette 12 of an adult person pushing the carrier, car seat and stroller combination 10 in which an infant 13 is seated and secured.

With specific reference now to FIG. 2 of the drawings, there is shown and illustrated a generally side elevation view of this preferred embodiment of the improved combination 10 of the present invention shown with the handle assembly 11 fully extended for steering and directing the wheeled combination infant carrier, car safety seat and stroller 10 following the removal thereof from a motor vehicle. The car seat generally indicated at 19 consists of a generally vertical back portion 20 for supporting the upper torso of the infant and a generally horizontal portion 21 for supporting the lower body of the infant or child. The car seat 19 together with the carrying handle 22 secured to opposite vertical side walls 23, 24 of the car seat 19 combines to form the infant carrier of the combination 10.

Also depicted in FIG. 2 is the second wheel 17 of a pair of wheels 14, 17 mounted to the other end of the single axle 15 is typically rotatably secured to the end of the axle 15 by means of a nut 18 threadably mated to the male threaded portion of the end of the axle 15. Of course, it should be noted that the wheels 14, 17 could readily be attached by means of a clip engaged in groove about the end portion of the axle 15, a cotter pin passed through a hole through the end portion of the axle 15, a cap which is frictionally engageable with the end of the axle 15, or the like.

The handle assembly 11 consists of a horizontal member 25 for manual gripping purposes and a pair of vertically-arranged tube members 26, 27 which are telescoping tubes enabling the handle assembly 11 to be extended and retracted. The horizonal member 25 is secured to the top ends 28, 29 of the vertical tubular members 26, 27 to provide a manual gripping surface thereto and to maintain the top ends 28, 29 of the tubular members 26, 27 in a fixed, spaced-apart relationship. The bottom ends 30, 31 of the vertical tubes 26, 27 are secured to the axle 15. The mid-portions of the vertical tubes 26, 27 between the top ends 28, 29 and the bottom ends 30, 31 are held in lateral spaced apart relationship by passing each of the vertical tubes 26, 27 through a pair of holes 32, 33 in the outerwardly facing, horizontally-directed lip 34 of the vertical back portion 20 of the car seat 19.

It should be noted, at this time, that by the combination of the horizontal member 25, the pair of holes 32, 33 in the lip 24 of the back portion 20 of the car seat 19, and the axle connection to the tubes 26, 27 form a highly rigid and strong arrangement between these three elemental connections for effectuating a lightweight, but strong, wheel steering handle assembly 11 for the wheels 14, 17 by which to maneuver the combination 10 when in the stroller mode. By this arrangement, the vertical tubes 26, 27 are prevented from significant lateral or transverse movement with respect to the vertical axis of the vertical tubes 26, 27.

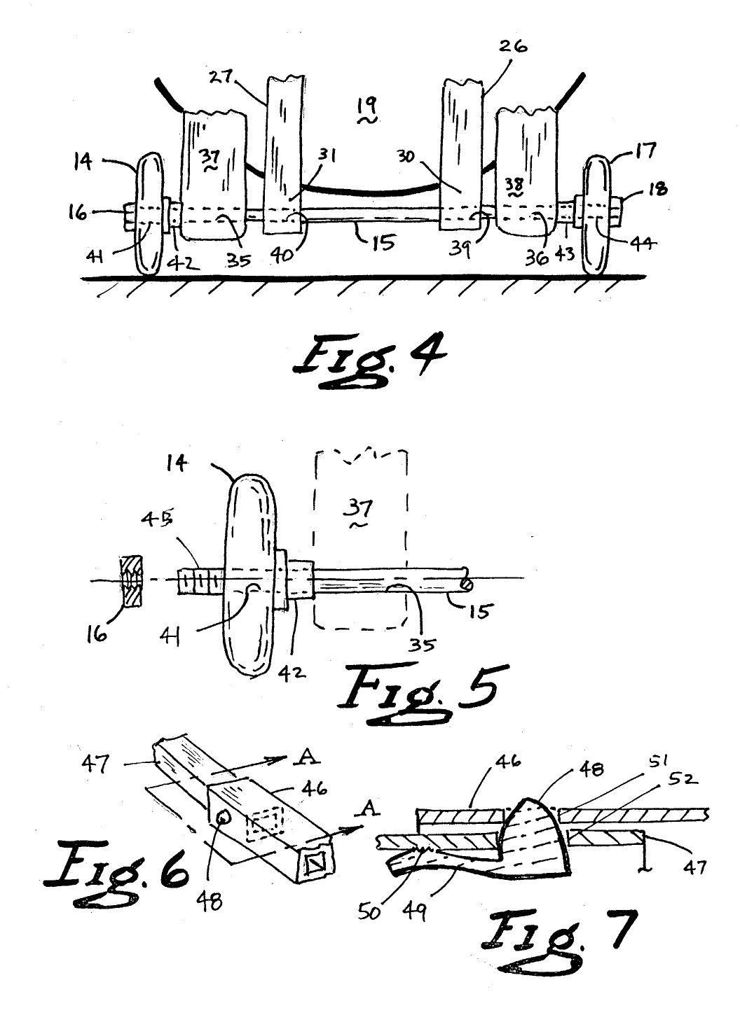

With special emphasis now on FIGS. 4 and 5, there is shown and illustrated that the axle 15 is secured to the combination 10 by a pair of apertures 35, 36 in each of the bottom portion of a pair of seat rigidizing and strengthening elements 37, 38 through which the axle 15 passes. The axle 15 also passes through holes 39, 40 of the bottom portions 30, 31 of the tubes.26, 27 to support the tubes 26, 27 with reference to the elements 37, 38.

The assembly view of FIG. 5 shows and illustrates how the wheel 14 having a hole 41 in the wheel 14 is mated over the threaded end 42 of the axle 15 with a first hollow spacer 42 disposed on the axle 15 in between the element 37 and the wheel 14 to prevent the wheel 14 from rubbing against the side of the element 37. A nut 16 is threadably mated to the male threaded end 45 of the axle 15 to capture the wheel 14 on the axle 15. The other end of the axle 15 has a similar threaded portion thereon and hole 44 of the wheel 17 is position on the axle 15 with a second hollow spacer 43 disposed on the axle 15 in between the element 38 through holes 39, 40 of the bottom portions 30, 31 and the wheel 17 to prevent the wheel 17 from rubbing against the side of the element 38. A nut 18 is threadably mated to the male threaded end (not shown) of the axle 15 to capture the wheel 17 on the axle 15 similar to the opposite end of the axle 15 as shown and depicted in FIG. 5 with wheel 14.

Turning now to FIGS. 6 and 7, there is illustrated a releaseable locking element for each of the intermediate, tube sections 46, 47 forming a telescoping tube member, such as 26 and 27. A pair of holes 51, 52 are formed in the wall of the respective tube sections 46. 47 and are alignable one with the other as shown. A bullet-shaped member 48 is formed having a spring member 49 disposed between the bottom of the bullet-shaped member 48 and is secured, typically by spot-welding as shown at 50 to the inside wall of the tube section 47. The bullet-shaped member 48 is spring-loaded by the spring member 49 to position it in the hole 52. When the larger of the telescoping tubes 46 is slideably positioned over the end of tube section 47, the bullet-shaped member 48 is forced into the hole 52 and inside of the tube 47 where it remains until the hole 51 is positioned over the bullet-shaped member 48. When this alignment occurs, the spring member 49 forces the bullet-shaped member 48 outwardly and into engagement with the rim formed by the hole 51 in the wall of the tube section 46, thereby locking the respective telescoping tube sections 46 and 47 with respect to each other and preventing further movement, both rotational and axial, between the two telescoping tube sections 46 and 47. Once locked, these tube sections 46 and 47 remain locked until unlocked by exerting substantial, significant force, typically axially-directed force, to cause the rim about the hole 51 to move over the bullet-shaped contour of the member 48 thereby forcing the bullet-shaped member 48 inwardly against the spring bias force of the spring 49 directing the bullet-shaped member 48 into the inside body of the tube section 47 and once the bullet-shaped member 48 is cleared, free movement between the telescoping tube sections 46 and 47 occurs.

With the foregoing general objects outlined, and with other specific objects in view, which will be more completely understood as the nature of the invention is more specifically detailed herein, the present invention resides in the combination and arrangement of parts and in the details of construction hereinafter described and claimed, it being understood that changes in the precise embodiment of the invention herein disclosed can be made within the scope of what is claimed without departing from the spirit of the invention.

And, finally, while the invention described and detailed herein is susceptible to various modifications and alternative forms, specific embodiments thereof have been shown by way of example in the drawings. It should be understood, however, that it is not intended to limit the invention to the particular forms disclosed, but, on the contrary, the intention is to cover all modifications, equivalents, and alternatives falling within the spirit and scope of the invention as defined by the appended claims.

What I claim as my invention is:

1. An improved combination stroller, car seat and carrier for infants comprising:
(a) a single axle with a pair of oppositely disposed ends, the axle being secured to the rear portion or the bottom of the car seat;
(b) a least one wheel mounted to one of the ends of the single axle;
(c) at least one wheel mounted to the other of the ends of the axle; and
(d) steering means for moving and directing the wheels mounted on the axle, said steering means having a handle portion and at least one collapsible pole means, said pole means having a pair of end portions thereon, one end portion being secured to said handle portion and the other end portion being secured to said axle.

2. The improved combination of claim 1, further comprising a least one collapsible pole means having one end mounted to the manual gripping portion, the mid-portion of the pole means secured to the back of the seat, and the end portion of the pole means mounted to a single axle, wherein the single axle is operably secured to the rearwardmost underside portion of the seat and the bottom of the collapsible handle is mounted thereto.

3. The improved combination of claim 1 further including locking means on the collapsible pole means.

4. The improved combination of claim 3 wherein the collapsible pole means including a plurality of telescoping members.

5. The improved combination of claim 1 further including a second collapsible pole means having a pair of end portions thereon, one end being secured to the handle portion and the other end portion being secured to said axle.

4. The improved combination of claim 5 wherein the pair of collapsible pole means each includes a plurality of telescoping hollow members.

5. The improved combination of claim 6 wherein the plurality of telescoping hollow members each have locking means to releasibly lock the telescoping hollow members in an extensible locked position.

6. The improved combination of claim 5 wherein the pair of collapsible pole means are each passed through the rim of the upper portion of the back of the seat through an aperture therethrough.

7. The improved combination of claim 6 wherein each of the bottom end portions of the pole means are secured to the single axle through an aperture therethrough.

8. The improved combination of claim 6 further comprising a pair of pair of seat rigidizing and strengthening members secured to the seat and extending therebeneath and having a pair of complementary holes therethrough for receiving the axle therethrough.

9. The improved combination of claim 8 further comprising a pair of spacers disposed inbetween the complementary holes in the pair of seat rigidizing and strengthening members and each of the wheels to position the wheels from engagement with the seat.
